(19) United States
(12) Patent Application Publication
(10) Pub. No.: US 2021/0288974 A1
(43) Pub. Date: Sep. 16, 2021

(54) ACCESS TOKEN FOR A VERIFIABLE CLAIM

(71) Applicant: Microsoft Technology Licensing, LLC., Redmond, WA (US)

(72) Inventors: Brandon MURDOCH, Reading (GB); Ankur PATEL, Sammamish, WA (US); Guillermo P. PROANO, Sammamish, WA (US)

(21) Appl. No.: 16/820,294

(22) Filed: Mar. 16, 2020

(51) Int. Cl. H04L 29/06

(52) U.S. Cl. CPC H04L 63/126; H04L 63/083

(57) ABSTRACT

Authorizing access to a verifiable claim so that a user who is the subject of the verifiable claim need not actively authorize the access. An access token is generated that is configured to provide access to a verifiable claim that was previously issued on behalf of a user that is the subject of the verifiable claim. The access token is then provided to an entity that is to be given access to the verifiable claim. The access token is next received from the entity when the entity attempts to access the verifiable claim and is validated. Finally, the entity is provided with access to the verifiable claim upon validation of the access token without the user having to actively authorize the access.

### BACKGROUND

A digital identity is a mechanism to keep track of an entity across different digital contexts. After an identity is determined, appropriate action can be taken related to the entity that has the identity. As an example, authorizations, privileges, customizations and access can be provided to the entity. Thus, digital identities are an important mechanism to ensure that information is restricted to appropriate trust boundaries via appropriate containment of authorizations and privileges. Digital identities are also an important mechanism to ensure a positive and consistent user experience when accessing their data and customizations.

Most currently used documents or records that prove identity are issued by centralized organizations, such as governments, corporations, schools, employers, or other service centers or regulatory organizations. These organizations often maintain every member's identity in a centralized identity management system. A centralized identity management system is a centralized information system used for organizations to manage the issued identities, their authentication, authorization, roles and privileges. Centralized identity management systems have been deemed as secure since they often use professionally maintained hardware and software. Typically, the identity issuing organization sets the terms and requirements for registering people with the organization. When a party needs to verify another party's identity, the verifying party often needs to go through the centralized identity management system to obtain information verifying and/or authenticating the other party's identity.

Decentralized Identifiers (DIDs) are a more recent type of identifier. Decentralized identifiers are independent of any centralized registry, identity provider, or certificate authority. Distributed ledger technology (such as blockchain) provides the opportunity for using fully decentralized identifiers. Distributed ledger technology uses distributed ledgers to record transactions between two or more parties in a verifiable way. Once a transaction is recorded, the data in the section of ledger cannot be altered retroactively without the alteration of all subsequent sections of ledger. This provides a fairly secure platform in which it is difficult or impossible to tamper with data recorded in the distributed ledger. Since a DID is generally not controlled by a centralized management system, but rather is owned by an owner of the DID, DIDs are sometimes referred to as identities without authority.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Existing computing technologies provide for a data structure called a “verifiable claim or credential”. In these technologies, a claims issuer makes one or more claims about a subject, and generates the verifiable claim. The verifiable claim include those claim(s) as well as proof instructions to prove that claim(s) have not been tampered with and were indeed issued by the claims issuer. The verifiable claim also often includes duration information metadata that defines a period of time that the verifiable claim is valid for use or that defines a specific number of times that the verifiable claim is authorized for use. The claims issuer then provides the verifiable claim to a claims holder, for presentation to any relying party that relies upon the veracity of those claims.

As an example, the claims issuer might be a computing system associated with a government agency in charge of issuing driver licenses. The government agency may generate a verifiable claim with claims about a citizen, such as the birthdate, residence address, weight, eye color, hair color, authorization to drive, restrictions on authorization to drive, and so forth. The government agency issues the verifiable claim to the citizen. If the user is stopped by law enforcement, the citizen may present the verifiable claim, whereby a computing system associated with law enforcement may use the proof instructions to verify that the claims were issued by the government agency and indeed have not been tampered with since issuance. In another example, an organization that provides inoculations may issue claims to a parent of a child that assert that the child has received certain inoculations. The parent may then present these inoculation claims to a school where the child is to attend.

During initial use of the verifiable claim, the holder typically is considered to be “present” by physically presenting the verifiable claim to a relying party or is “present” by being online or the like, if the verifiable claim is presented online using a device of the holder such as a mobile phone. This allows the holder to actively authorize access to the verifiable claim because the holder either shows the verifiable claim to the relying party or the holder pushes a button or the like on the device.

After the initial use of the verifiable claim, a relying party may need to access the verifiable claim one or more additional times when providing services to the holder. In addition, the issuer may also need to access the verifiable claim to update the verifiable claim as needed. However, the holder is not always able to physically present the verifiable claim the relying party since he or she may not physically be in the presence of the relying party. In addition, the holder is always not online and thus able to push the button on the device to authorize access to the verifiable claim. Accordingly, the holder may not be able to authorize access to the verifiable claim at the time that the issuer and/or relying party need to access to the verifiable claim.

The principles described herein aim to solve at least some of the above-mentioned problems by providing a way for the holder to securely provide access to the verifiable claim so that it can be used or modified by the issuer and/or the relying party as needed. At a later date, the holder is able to revoke the authorization to access the verifiable claim. From the perspective of the holder, this happens in the background without any direct input from him or her, thus allowing the issuer and/or the relying party to access the verifiable claim when they need access without having to wait for the holder to be present. The provides for efficiency gains and saved computing resources as time is not lost waiting on the holder to authorize the access.

In one embodiment, an access token is generated that is configured to provide access to a verifiable claim that was previously issued on behalf of a user that is the subject of the verifiable claim. The access token is then provided to an entity that is to be given access to the verifiable claim. The access token is next received from the entity when the entity attempts to access the verifiable claim and is validated. Finally, the entity is provided with access to the verifiable claim upon validation of the access token without the user having to actively authorize the access.

In one embodiment, the access token is attached to the verifiable claim and the verifiable claim is provided to the entity. In another embodiment, the entity is an issuing entity that issued the verifiable claim on behalf of the user. In still another embodiment, the entity is a relying party that uses the verifiable claim when providing a service to the user.

In an embodiment, providing the entity with access to the verifiable claim includes allowing the entity to update one or more properties of the verifiable claim. In one embodiment, updating the one or more properties of the verifiable claim includes updating duration information metadata that specifies a time period that the verifiable claim is valid or a predetermined number of times the verifiable is valid for use. In a further embodiment, providing the entity with access to the verifiable claim includes allowing the entity to use the verifiable claim when providing a service to the user.

In one embodiment, the verifiable claim includes at least (1) a Decentralized Identifier (DID), (2) a property of the subject entity, (3) a value corresponding to the property, (4) a unique identifier identifying the corresponding verifiable claims, and (5) one or more conditions for accessing the verifiable claims. In one embodiment, the one or more conditions include at least one of the following: (1) requiring a relying entity to pay a predetermined amount of value, (2) requiring a relying entity to provide identification information, (3) requiring a relying entity to provide one or more verifiable claim(s), (4) requiring a relying entity to grant permission for accessing a portion of data, or (5) requiring a relying entity to provide a particular service.

In one embodiment, revocation data is generated that is configured to revoke the access token. The revocation data is provided to the entity. The access to the verifiable claim is revoked.

In one embodiment, the computing system is associated with a management module controlled by the user. In another embodiment, the computing system is associated with an identity hub controlled by the user. In a further embodiment, the verifiable claim is stored in an identity hub controlled by the user.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates an example computing system in which the principles described herein may be employed;

FIG. 2 illustrates an example environment for creating a decentralized identification or identifier (DID);

FIG. 3 illustrates an example environment for various DID management operations and services;

FIG. 4 illustrates an example decentralized personal storage or identity hub;

FIG. 5 illustrates an example environment, in which the principles described herein are implemented;

FIG. 6A illustrates an example claim;

FIG. 6B illustrates an example verifiable claim;

FIG. 7A illustrates an example embodiment that can be used to authorize access to a verifiable claim so that a user who is the subject of the verifiable claim need not actively authorize access to the verifiable claim;

FIG. 7B illustrates an alternative embodiment of the environment of FIG. 7A;

FIG. 7C illustrates an alternative embodiment of the environment of FIG. 7A;

FIG. 7D illustrates an alternative embodiment of the environment of FIG. 7A;

FIG. 8 illustrates a specific case of use by an issuer of an access token;

FIG. 9 illustrates a specific case of use by a relying party of an access token; and

FIG. 10 illustrates a flow chart of an example method for authorizing access to a verifiable claim so that a user who is the subject of the verifiable claim need not actively authorize the access.

### DETAILED DESCRIPTION

Authorizing access to a verifiable claim so that a user who is the subject of the verifiable claim need not actively authorize the access. An access token is generated that is configured to provide access to a verifiable claim that was previously issued on behalf of a user that is the subject of the verifiable claim. The access token is then provided to an entity that is to be given access to the verifiable claim. The access token is next received from the entity when the entity attempts to access the verifiable claim and is validated. Finally, the entity is provided with access to the verifiable claim upon validation of the access token without the user having to actively authorize the access.

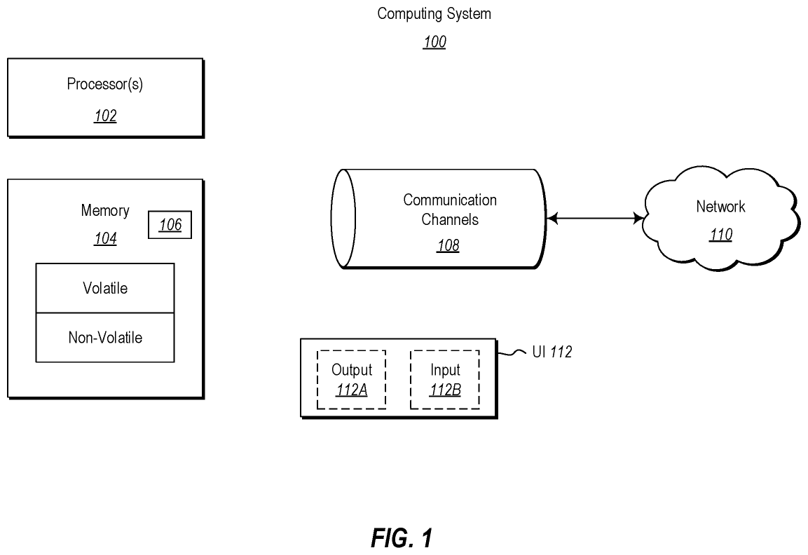

Because the principles described herein is performed in the context of a computing system, some introductory discussion of a computing system will be described with respect to FIG. 1. Then, this description will return to the principles of the embodiments disclosed herein with respect to the remaining figures.

Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that are executed by a processor. The memory takes any form and depends on the nature and form of the computing system. A computing system is distributed over a network environment and includes multiple constituent computing systems.

As illustrated in FIG. 1, in its most basic configuration, a computing system 100 typically includes at least one hardware processing unit 102 and memory 104. The processing unit 102 includes a general-purpose processor and also includes a field-programmable gate array (FPGA), an application-specific integrated circuit (ASIC), or any other specialized circuit. The memory 104 is physical system memory, which is volatile, non-volatile, or some combination of the two. The term “memory” also be used herein to refer to non-volatile mass storage such as physical storage media. If the computing system is distributed, the processing, memory and/or storage capability is distributed as well.

The computing system 100 also has thereon multiple structures often referred to as an “executable component”. For instance, memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component include software objects, routines, methods, and so forth, that is executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such a structure is computer-readable directly by the processors (as is the case if the executable component were binary). Alternatively, the structure is structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, that are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions are embodied on one or more computer-readable media that form a computer program product. An example of such an operation involves the manipulation of data. If such acts are implemented exclusively or near-exclusively in hardware, such as within an FPGA or an ASIC, the computer-executable instructions are hardcoded or hard-wired logic gates. The computer-executable instructions (and the manipulated data) is stored in the memory 104 of the computing system 100. Computing system 100 also contain communication channels 108 that allow the computing system 100 to communicate with other computing systems over, for example, network 110.

While not all computing systems require a user interface, in some embodiments, the computing system 100 includes a user interface system 112 for use in interfacing with a user. The user interface system 112 includes output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse or other pointer input, sensors of any type, and so forth.

Embodiments described herein comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special purpose computing system, or special purpose processing device to perform a certain function or group of functions. Alternatively, or in addition, the computer-executable instructions configure the computing system to perform a certain function or group of functions. The computer executable instructions are, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention is practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, data centers, wearables (such as glasses) and the like. In some cases, the invention also is practiced in distributed system environments where local and remote computing systems, which are linked (either by hardwired data links, wireless data links, or by a combination of hardwired and wireless data links) through a network, both perform tasks. In a distributed system environment, program modules are located in both local and remote memory storage devices.

Those skilled in the art will also appreciate that the invention is practiced in a cloud computing environment. Cloud computing environments are distributed, although this is not required. When distributed, cloud computing environments are distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures discuss various computing system which corresponds to the computing system 100 previously described. The computing systems of the remaining figures include various components or functional blocks that implement the various embodiments disclosed herein as will be explained. The various components or functional blocks are implemented on a local computing system or are implemented on a distributed computing system that includes elements resident in the cloud or that implement aspects of cloud computing. The various components or functional blocks are implemented as software, hardware, or a combination of software and hardware. The computing systems of the remaining figures include more or less than the components illustrated in the figures and some of the components are combined as circumstances warrant. Although not necessarily illustrated, the various components of the computing systems access and/or utilize a processor and memory, such as processing unit 102 and memory 104, as needed to perform their various functions.

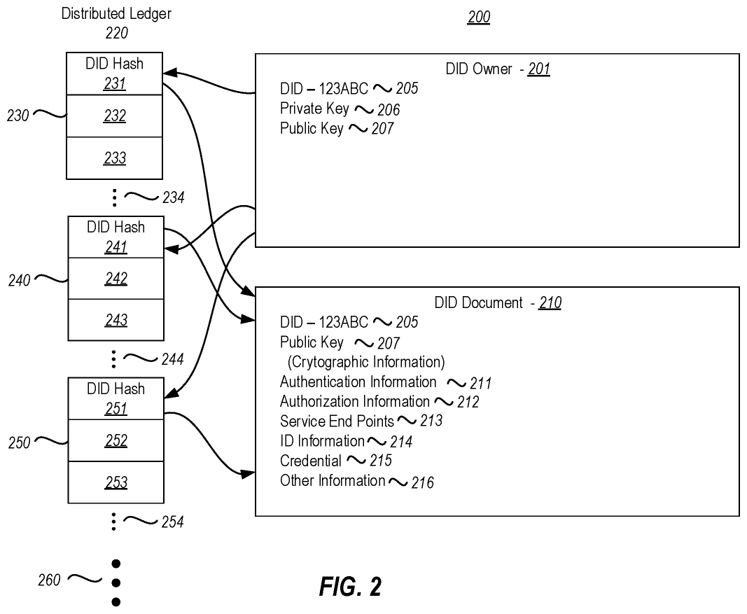

Some introductory discussions of a decentralized identification (DID) and the environment in which they are created and reside will now be given with respect to FIG. 2. As illustrated in FIG. 2, a DID owner 201 owns or controls a DID 205 that represents an identity of the DID owner 201. The DID owner 201 registers a DID using a creation and registration service, which will be explained in more detail below.

The DID owner 201 is any entity that could benefit from a DID. For example, the DID owner 201 is a human being or an organization of human beings. Such organizations might include a company, department, government, agency, or any other organization or group of organizations. Each individual human being might have a DID while the organization(s) to which each belongs might likewise have a DID.

The DID owner 201 alternatively be a machine, system, or device, or a collection of machine(s), device(s) and/or system(s). In still other embodiments, the DID owner 201 is a subpart of a machine, system or device. For instance, a device could be a printed circuit board, where the subpart of that circuit board are individual components of the circuit board. In such embodiments, the machine or device has a DID and each subpart also have a DID. A DID owner might also be a software component such as the executable component 106 described above with respect to FIG. 1. An example of a complex executable component 106 might be an artificial intelligence. An artificial intelligence also owns a DID.

Thus, the DID owner 201 is any reasonable entity, human or non-human, that is capable of creating the DID 205 or at least having the DID 205 created for and associated with them. Although the DID owner 201 is shown as having a single DID 205, this need not be the case as there is any number of DIDs associated with the DID owner 201 as circumstances warrant.

As mentioned, the DID owner 201 creates and registers the DID 205. The DID 205 is any identifier that is associated with the DID owner 201. Preferably, that identifier is unique to that DID owner 201, at least within a scope in which the DID is anticipated to be in use. As an example, the identifier is a locally unique identifier, and perhaps more desirably a globally unique identifier for identity systems anticipated to operate globally. In some embodiments, the DID 205 is a Uniform Resource Identifier (URI) (such as a Uniform Resource Locator (URL)) or other pointers that relates the DID owner 201 to mechanism to engage in trustable interactions with the DID owner 201.

The DID 205 is “decentralized” because it does not require a centralized, third party management system for generation, management, or use. Accordingly, the DID 205 remains under the control of the DID owner 201. This is different from conventional centralized IDs based trust on centralized authorities and that remain under control of the corporate directory services, certificate authorities, domain name registries, or other centralized authority (referred to collectively as “centralized authorities” herein). Accordingly, the DID 205 is any identifier that is under the control of the DID owner 201 and independent of any centralized authority.

In some embodiments, the structure of the DID 205 is as simple as a username or some other human-understandable term. However, in other embodiments, the DID 205 preferably be a random string of numbers and letters for increased security. In one embodiment, the DID 205 is a string of 128 letters and numbers. Accordingly, the embodiments disclosed herein are not dependent on any specific implementation of the DID 205. In a very simple example, the DID 205 is shown as “123ABC”.

As also shown in FIG. 2, the DID owner 201 has control of a private key 206 and public key 207 pair that are associated with the DID 205. Because the DID 205 is independent of any centralized authority, the private key 206 should at all times be fully in control of the DID owner 201. That is, the private and public keys should be generated in a decentralized manner that ensures that they remain under the control of the DID owner 201.

As will be described in more detail to follow, the private key 206 and public key 207 pair is generated on a device controlled by the DID owner 201. The private key 206 and public key 207 pairs should not be generated on a server controlled by any centralized authority as this causes the private key 206 and public key 207 pairs to not be fully under the control of the DID owner 201 at all times. Although FIG. 2 and this description have described a private and public key pair, it will also be noted that other types of reasonable cryptographic information and/or mechanism also be used as circumstances warrant.

FIG. 2 also illustrates a DID document 210 that is associated with the DID 205. As will be explained in more detail to follow, the DID document 210 is generated at the time that the DID 205 is created. In its simplest form, the DID document 210 describes how to use the DID 205. Accordingly, the DID document 210 includes a reference to the DID 205, which is the DID that is described by the DID document 210. In some embodiments, the DID document 210 is implemented according to methods specified by a distributed ledger 220 that will be used to store a representation of the DID 205 as will be explained in more detail to follow. Thus, the DID document 210 has different methods depending on the specific distributed ledger.

The DID document 210 also includes the public key 207 created by the DID owner 201 or some other equivalent cryptographic information. The public key 207 is used by third-party entities that are given permission by the DID owner 201 to access information and data owned by the DID owner 201. The public key 207 also be used by verifying that the DID owner 201, in fact, owns or controls the DID 205.

The DID document 210 also includes authentication information 211. The authentication information 211 specify one or more mechanisms by which the DID owner 201 is able to prove that the DID owner 201 owns the DID 205. In other words, the mechanisms of authentication information 211 show proof of a binding between the DID 205 (and thus it's DID owner 201) and the DID document 210. In one embodiment, the authentication information 211 specifies that the public key 207 be used in a signature operation to prove the ownership of the DID 205. Alternatively, or in addition, the authentication information 211 specifies that the public key 207 be used in a biometric operation to prove ownership of the DID 205. Accordingly, the authentication information 211 includes any number of mechanisms by which the DID owner 201 is able to prove that the DID owner 201 owns the DID 205.

The DID document 210 also includes authorization information 212. The authorization information 212 allows the DID owner 201 to authorize third party entities the rights to modify the DID document 210 or some part of the document without giving the third party the right to prove ownership of the DID 205. For example, the authorization information 212 allows the third party to update any designated set of one or more fields in the DID document 210 using any designated update mechanism. Alternatively, the authorization information allows the third party to limit the usages of DID 205 by the DID owner 201 for a specified time period. This is useful when the DID owner 201 is a minor child and the third party is a parent or guardian of the child. The authorization information 212 allows the parent or guardian to limit the use of the DID 205 until such time as the child is no longer a minor.

The authorization information 212 also specifies one or more mechanisms that the third party will need to follow to prove they are authorized to modify the DID document 210. In some embodiments, this mechanism is similar to those discussed previously with respect to the authentication information 211.

The DID document 210 also includes one or more service endpoints 213. A service endpoint includes a network address at which a service operates on behalf of the DID owner 201. Examples of specific services include discovery services, social networks, file storage services such as identity servers or hubs, and verifiable claim repository services. Accordingly, the service endpoints 213 operate as pointers for the services that operate on behalf of the DID owner 201. These pointers are used by the DID owner 201 or by third party entities to access the services that operate on behalf of the DID owner 201. Specific examples of service endpoints 213 will be explained in more detail to follow.

The DID document 210 further includes identification information 214. The identification information 214 includes personally identifiable information such as the name, address, occupation, family members, age, hobbies, interests, or the like of DID owner 201. Accordingly, the identification information 214 listed in the DID document 210 represents a different persona of the DID owner 201 for different purposes. For instance, a persona is pseudo-anonymous, e.g., the DID owner 201 include a pen name in the DID document when identifying him or her as a writer posting articles on a blog; a persona is fully anonymous, e.g., the DID owner 201 only want to disclose his or her job title or other background data (e.g., a school teacher, an FBI agent, an adult older than 21 years old, etc.) but not his or her name in the DID document; and a persona is specific to who the DID owner 201 is as an individual, e.g., the DID owner 201 includes information identifying him or her as a volunteer for a particular charity organization, an employee of a particular corporation, an award winner of a particular award, etc.

The DID document 210 also includes credential information 215, which may also be referred to herein as an attestation. The credential information 215 (also referred to as a verifiable claim) is any information that is associated with the DID owner 201′s background. For instance, the credential information 215 is (but not limited to) a qualification, an achievement, a government ID, a government right such as a passport or a driver's license, a digital asset provider or bank account, a university degree or other educational history, employment status and history, or any other information about the DID owner 201′s background.

The DID document 210 also includes various other information 216. In some embodiments, the other information 216 includes metadata specifying when the DID document 210 was created and/or when it was last modified. In other embodiments, the other information 216 includes cryptographic proofs of the integrity of the DID document 210. In still further embodiments, the other information 216 includes additional information that is either specified by the specific method implementing the DID document or desired by the DID owner 201.

FIG. 2 also illustrates a distributed ledger or blockchain 220. The distributed ledger 220 is any decentralized, distributed network that includes various computing systems that are in communication with each other. For example, the distributed ledger 220 includes a first distributed computing system 230, a second distributed computing system 240, a third distributed computing system 250, and any number of additional distributed computing systems as illustrated by the ellipses 260. The distributed ledger or blockchain 220 operates according to any known standards or methods for distributed ledgers. Examples of conventional distributed ledgers that correspond to the distributed ledger or blockchain 220 include, but are not limited to, Bitcoin [BTC], Ethereum, and Litecoin.

In the context of DID 205, the distributed ledger or blockchain 220 is used to store a representation of the DID 205 that points to the DID document 210. In some embodiments, the DID document 210 is stored on the actually distributed ledger. Alternatively, in other embodiments the DID document 210is stored in a data storage (not illustrated) that is associated with the distributed ledger or blockchain 220.

As mentioned, a representation of the DID 205 is stored on each distributed computing system of the distributed ledger or blockchain 220. For example, in FIG. 2 this is shown as the DID has 231, DID has 241, and DID has 251, which are ideally identical copies of the same DID. The DID hash 231, DID hash 241, and DID hash 251 then point to the location of the DID document 210. The distributed ledger or blockchain 220 also store numerous other representations of other DIDs as illustrated by references 232, 233, 234, 242, 243, 244, 252, 253, and 254.

In one embodiment, when the DID owner 201 creates the DID 205 and the associated DID document 210, the DID has 231, DID has 241, and DID hash 251 are written to the distributed ledger or blockchain 220. The distributed ledger or blockchain 220 thus records that the DID 205 now exists. Since the distributed ledger or blockchain 220 is decentralized, the DID 205 is not under the control of any entity outside of the DID owner 201. The DID hash 231, DID has 241, and DID has 251 includes, in addition to the pointer to the DID document 210, a record or timestamp that specifies when the DID 205 was created. At a later date when modifications are made to the DID document 210, this also is recorded in DID has 231, DID has 241, and DID has 251. The DID has 231, DID has 241, and DID hash 251 further includes a copy of the public key 207 so that the DID 205 is cryptographically bound to the DID document 210.

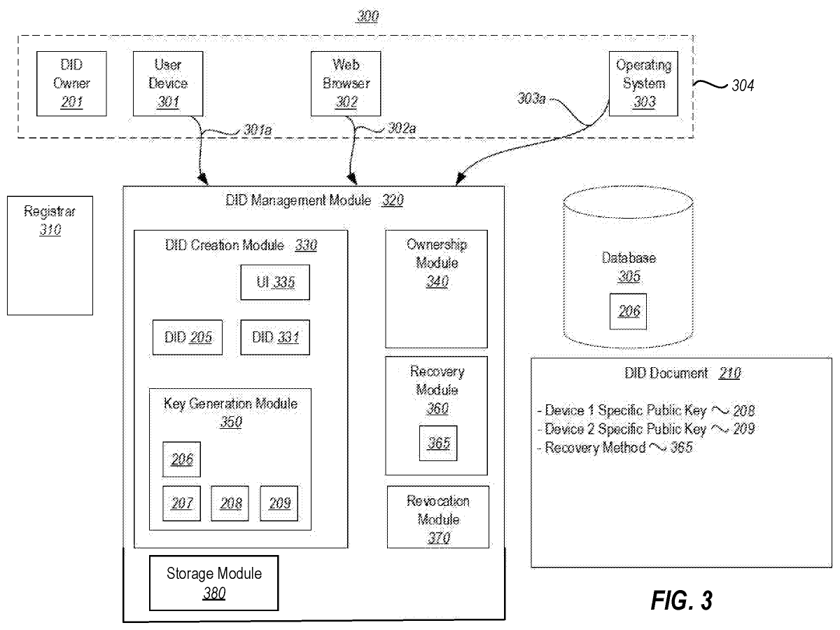

Having described DIDs and how they operate generally with reference to FIG. 2, specific embodiments of DID environments will now be explained. Turning to FIG. 3, a computing system environment 300 that is used to perform various DID management operations and services will now be explained. It will be appreciated that the environment of FIG. 3 reference elements from FIG. 2 as needed for ease of explanation.

As shown in FIG. 3, the computing system environment 300 includes various devices and computing systems that are owned or otherwise under the control of the DID owner 201. These include a user device 301. The user device 301 is, but is not limited to, a mobile device such as a smart phone, a computing device such as a laptop computer, or any device such as a car or an appliance that includes computing abilities. The user device 301 includes a web browser 302 operating on the device and an operating system 303 operating the device. More broadly speaking, the dashed line 304 represents that all of these devices are owned or otherwise under the control of the DID owner 201.

The computing system environment 300 also includes a DID management module 320. It will be noted that in operation, the DID management module 320 resides on and is executed by one or more of user device 301, web browser 302, and the operating system 303 as illustrated by respective lines 301a, 302a, and 303a. Accordingly, the DID management module 320 is shown as being separate for ease of explanation. In some embodiments, the DID management module 320 is referred to as a “digital wallet” or a “user agent”.

As shown in FIG. 3, the DID management module 320 includes a DID creation module 330. The DID creation module 330 is used by the DID owner 201 to create the DID 205 or any number of additional DIDs, such as DID 331. In one embodiment, the DID creation module includes or otherwise has access to a User Interface (UI) element 335 that guides the DID owner 201 in creating the DID 205. The DID creation module 330 has one or more drivers that are configured to work with specific distributed ledgers such as distributed ledger 220 so that the DID 205 complies with the underlying methods of that distributed ledger.

A specific embodiment will now be described. For example, the UI 335 prompt for the user to enter a username or some other human recognizable name. This name is used as a display name for the DID 205 that will be generated. As previously described, the DID 205 is a long string of random numbers and letters and so having a human-recognizable name for a display name is advantageous. The DID creation module 330 then generates the DID 205. In the embodiments having the UI 335, the DID 205 is shown in a listing of identities and is associated with the human-recognizable name.

The DID creation module 330 also included a key generation module 350. The key generation module generates the private key 206 and public key 207 pair previously described. The DID creation module 330 uses the DID 205 and the private and public key pair to generate the DID document 210.

In operation, the DID creation module 330 accesses a registrar 310 that is configured to the specific distributed ledger that will be recording the transactions related to the DID 205. The DID creation module 330 uses the registrar 310 to record DID hash 231, DID hash 241, and DID hash 251 in the distributed ledger in the manner previously described, and to store the DID document 210 in the manner previously described. This process uses the public key 207 in the hash generation.

In some embodiments, the DID management module 320 includes an ownership module 340. The ownership module 340 provides mechanisms that ensure that the DID owner 201 is in sole control of the DID 205. In this way, the provider of the DID management module 320 is able to ensure that the provider does not control the DID 205 but is only providing the management services.

As previously discussed, the key generation module 350 generates the private key 206 and public key 207 pair and the public key 207 is then recorded in the DID document 210. Accordingly, the public key 207 is usable by all devices associated with the DID owner 201 and all third parties that desire to provide services to the DID owner 201. Accordingly, when the DID owner 201 desires to associate a new device with the DID 205, the DID owner 201 executes the DID creation module 330 on the new device. The DID creation module 330 then uses the registrar 310 to update the DID document 210 to reflect that the new device is now associated with the DID 205, which update would be reflected in a transaction on the distributed ledger 220, as previously described.

In some embodiments, however, it is advantageous to have a public key per user device 301 owned by the DID owner 201 as this allows the DID owner 201 to sign with the device-specific public key without having to access a general public key. In other words, since the DID owner 201 will use different devices at different times (for example using a mobile phone in one instance and then using a laptop computer in another instance), it is advantageous to have a key associated with each device to provide efficiencies in signing using the keys. Accordingly, in such embodiments the key generation module 350 generates additional public keys 208 and 209 when the additional devices execute the DID creation module 330. These additional public keys are associated with the private key 206 or in some instances are paired with a new private key.

In those embodiments where the additional public keys 208 and 209 are associated with different devices, the additional public keys 208 and 209 are recorded in the DID document 210 as being associated with those devices. This is shown in FIG. 3. It will be appreciated that the DID document 210 often includes the information (information 205, 207 and 211 through 216) previously described in relation to FIG. 2 in addition to the information (information 208, 209 and 365) shown in FIG. 3. If the DID document 210 existed prior to the device-specific public keys being generated, then the DID document 210 would be updated by the DID creation module 330 via the registrar 310 and this would be reflected in an updated transaction on the distributed ledger 220.

In some embodiments, the DID owner 201 often desires to keep secret the association of a device with a public key or the association of a device with the DID 205. Accordingly, the DID creation module 330 causes that such data be secretly shown in the DID document 210.

As described thus far, the DID 205 has been associated with all the devices under the control of the DID owner 201, even when the devices have their own public keys. However, in some embodiments it may be useful for each device or some subset of devices under the control of the DID owner 201 to each have their own DID. Thus, in some embodiments the DID creation module 330 generates an additional DID, for example DID 331, for each device. The DID creation module 330 then generates private and public key pairs and DID documents for each of the devices and has them recorded on the distributed ledger 220 in the manner previously described. Such embodiments are advantageous for devices that change ownership as it is possible to associate the device-specific DID to the new owner of the device by granting the new owner authorization rights in the DID document and revoking such rights from the old owner.

As mentioned, to ensure that the private key 206 is totally in the control of the DID owner 201, the private key 206 is created on the user device 301, web browser 302, or operating system 303 that is owned or controlled by the DID owner 201 that executed the DID management module 320. In this way, there is little chance that of a third-party (and most consequentially, the provider of the DID management module 320) gaining control of the private key 206.

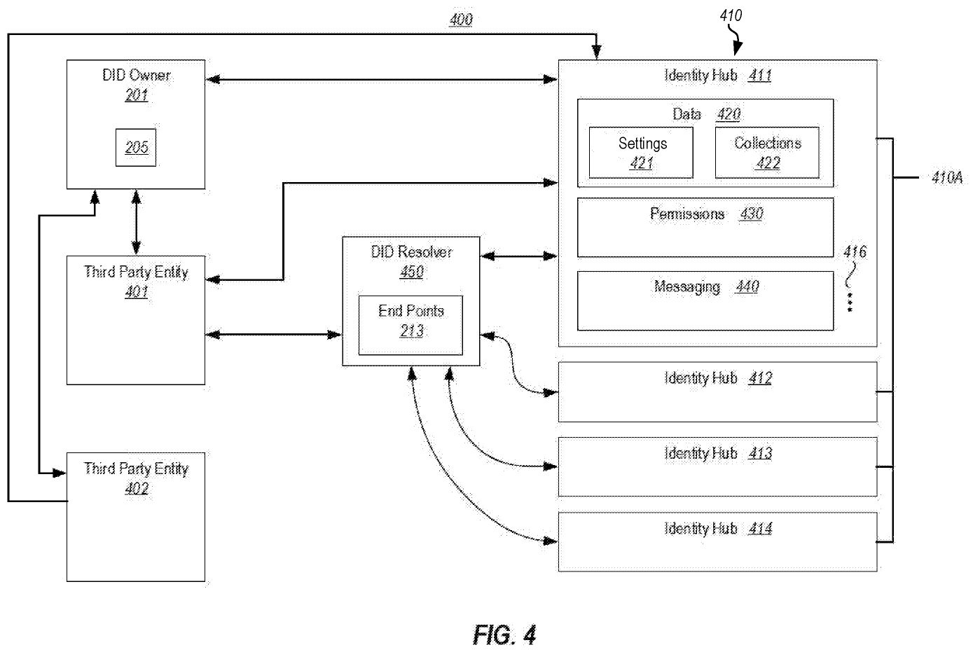

However, there is a chance that the device storing the private key 206 is lost by the DID owner 201, which causes the DID owner 201 to lose access to the DID 205. Accordingly, in some embodiments, the UI 335 includes the option to allow the DID owner 201 to export the private key 206 to an off device secured database 305 that is under the control of the DID owner 201. As an example, the database 305 is one of the identity hubs 410 described below with respect to FIG. 4. A storage module 380 is configured to store data (such as the private key 206 or the credential information 215 made by or about the DID owner 201) off device in the database 305 or in the identity hubs 410 that will be described in more detail to follow. Of course, in some embodiments the storage module 380 stores at least some data on the device if the device has sufficient storage resources. In some embodiments, the private key 206 is stored as a QR code that is scanned by the DID owner 201.

In other embodiments, the DID management module 320 includes a recovery module 360 that is used to recover a lost private key 206. In operation, the recovery module 360 allows the DID owner 201 to select one or more recovery mechanisms 365 at the time the DID 205 is created that are later used to recover the lost private key. In those embodiments having the UI 335, the UI 335 allows the DID owner 201 to provide information that will be used by the one or more recovery mechanisms 365 during recovery. The recovery module 360 run on any device associated with the DID 205.

The DID management module 320 also included a revocation module 370 that is used to revoke or sever a device from the DID 205. In operation, the revocation module uses the UI 335, which allows the DID owner 201 to indicate a desire to remove a device from being associated with the DID 205. In one embodiment, the revocation module 370 accesses the DID document 210 and causes all references to the device to be removed from the DID document 210. Alternatively, the public key for the device is removed. This change in the DID document 210 is then reflected as an updated transaction on the distributed ledger 220 as previously described.

FIG. 4 illustrates an embodiment of a computing system environment 400 in which a DID such as DID 205 is utilized. Specifically, the computing system environment 400 is used to describe the use of the DID 205 in relation to one or more decentralized stores or identity hubs 410 that are each under the control of the DID owner 201 to store data belonging to or regarding the DID owner 201. For instance, data is stored within the identity hubs using the storage module 380 of FIG. 3. It will be noted that FIG. 4 includes references to elements first discussed in relation to FIG. 2 or 3 and thus uses the same reference numeral for ease of explanation.

In one embodiment, the identity hubs 410 are multiple instances of the same identity hub. This is represented by the line 410A. Thus, the various identity hubs 410 include at least some of the same data and services. Accordingly, if a change is made to part of at least some of the data (and potentially any part of any of the data) in one of the identity hubs 410, the change is reflected in one or more of (and perhaps all of) the remaining identity hubs.

The identity hubs 410 may be any data store that is in the exclusive control of the DID owner 201. As an example only, the first identity hub 411 and second identity hub 412 are implemented in cloud storage (perhaps within the same cloud, or even on different clouds managed by different cloud providers) and thus are able to hold a large amount of data. Accordingly, a full set of the data is storable in these identity hubs.

However, the identity hubs 413 and 414 may have less memory space. Accordingly, in these identity hubs a descriptor of the data stored in the first and second identity hubs is included. Alternatively, a record of changes made to the data in other identity hubs is included. Thus, changes in one of the identity hubs 410 are either fully replicated in the other identity hubs or at least a record or descriptor of that data is recorded in the other identity hubs.

Because the identity hubs are multiple instances of the same identity hub, only a full description of the first identity hub 411 will be provided as this description also applies to the identity hubs 412 through 414. As illustrated, identity hub 411 includes data storage 420. The data storage 420 is used to store any type of data that is associated with the DID owner 201. In one embodiment the data is a collection 422 of a specific type of data corresponding to a specific protocol. For example, the collection 422 may be medical records data that corresponds to a specific protocol for medical data. The collection 422 also includes other types of data, such as attestations 215 made by or about the DID owner 201.

In one embodiment, the stored data has different authentication and privacy settings 421 associated with the stored data. For example, a first subset of the data has a setting 421 that allows the data to be publicly exposed, but that does not include any authentication to the DID owner 201. This type of data is typically for relatively unimportant data such as color schemes and the like. A second subset of the data has a setting 421 that allows the data to be publicly exposed and that includes authentication to the DID owner 201. A third subset of the data has a setting 421 that encrypts the subset of data with the private key 206 and public key 207 pair (or some other key pair) associated with the DID owner 201. This type of data will require a party to have access to the public key 207 (or to some other associated public key) in order to decrypt the data. This process also includes authentication to the DID owner 201. A fourth subset of the data has a setting 421 that restricts this data to a subset of third parties. This requires that public keys associated with the subset of third parties be used to decrypt the data. For example, the DID owner 201 causes the setting 421 to specify that only public keys associated with friends of the DID owner 201 are able to decrypt this data. With respect to data stored by the storage module 380, these settings 421 are at least partially composed by the storage module 380 of FIG. 3.

In some embodiments, the identity hub 411 has a permissions module 430 that allows the DID owner 201 to set specific authorization or permissions for third parties such as third parties 401 and 402 to access the identity hub. For example, the DID owner 201 provides access permission to his or her spouse to all the data 420. Alternatively, the DID owner 201 allows access to his or her doctor for any medical records. It will be appreciated that the DID owner 201 is able to give permission to any number of third parties to access a subset of the data 420. This will be explained in more detail to follow. With respect to data stored by the storage module 380, these access permissions 430 are at least partially composed by the storage module 380 of FIG. 3.

The identity hub 411 also include a messaging module 440. In operation, the messaging module allows the identity hub to receive messages such as requests from parties such as third parties 401 and 402 to access the data and services of the identity hub. In addition, the messaging module 440 allows the identity hub 411 to respond to the messages from the third parties and to also communicate with a DID resolver 450. This will be explained in more detail to follow. The ellipsis 416 represents that the identity hub 411 may have additional services as circumstances warrant.

In one embodiment, the DID owner 201 wishes to authenticate a new user device 301 with the identity hub 411 that is already associated with the DID 205 in the manner previously described. Accordingly, the DID owner 201 utilizes the DID management module 320 associated with the new user device 301 to send a message to the identity hub 411 asserting that the new user device is associated with the DID 205 of the DID owner 201.

However, the identity hub 411 is not able to initially recognize the new device as being owned by the DID owner 201. Accordingly, the identity hub 411 uses the messaging module 440 to contact the DID resolver 450. The message sent to the DID resolver 450 includes the DID 205.

The DID resolver 450 is a service, application, or module that is configured in operation to search the distributed ledger 220 for DID documents associated with DIDs. Accordingly, in the embodiment the DID resolver 450 searches the distributed ledger 220 using the DID 205, which should result in the DID resolver 450 finding the DID document 210. The DID document 210 is then provided to the identity hub 411.

As discussed previously, the DID document 210 includes a public key 208 or 209 that is associated with the new user device 301. To verify that the new user device is owned by the DID owner 201, the identity hub 411 provides a cryptographic challenge to the new user device 301 using the messaging module 440. This cryptographic challenge is structured such that only a device having access to the private key 206 will be able to successfully answer the challenge.

In this embodiment, since the new user device is owned by DID owner 201 and thus has access to the private key 206, the challenge is successfully answered. The identity hub 411 then records in the permissions 430 that the new user device 301 is able to access the data and services of the identity hub 411 and also the rest of the identity hubs 410.

It will be noted that this process of authenticating the new user device 301 was performed without the need for the DID owner 201 to provide any username, password or the like to the provider of the identity hub 411 (i.e., the first cloud storage provider) before the identity hub 411 could be accessed. Rather, the access was determined in a decentralized manner based on the DID 205, the DID document 210, and the associated public and private keys. Since these were at all times in the control of the DID owner 201, the provider of the identity hub 411 was not involved and thus has no knowledge of the transaction or of any personal information of the DID owner 201.

In another example embodiment, the DID owner 201 provides the DID 205 to the third-party 401 so that the third-party is able to access data or services stored on the identity hub 411. For example, the DID owner 201 is a human who is at a scientific conference who desires to allow the third-party 401, who is also a human, access to his or her research data. Accordingly, the DID owner 201 provides the DID 205 to the third-party 401.

Once the third-party 401 has access to the DID 205, he or she accesses the DID resolver 450 to access the DID document 210. As previously discussed, the DID document 210 includes a service end point 213 that is an address or pointer to services associated with the decentralized identity.

Completing the research data example, the third-party 401 sends a message to the messaging module 440 asking for permission to access the research data. The messaging module 440 sends a message to the DID owner 201 asking if the third-party 401 should be given access to the research data. Because the DID owner desires to provide access to this data, the DID owner 201 allows permission to the third-party 401 and this permission is recorded in the permissions 430.

The messaging module 440 then messages the third-party 401 informing the third-party that he or she is able to access the research data. The identity hub 411 and the third-party 401 directly communicate so that the third-party is able to access the data. It will be noted that in many cases, it will actually be an identity hub associated with the third-party 401 that communicates with the identity hub 411. However, it may be a device of the third-party 401 that does the communication.

Advantageously, the above described process allows the identity hub 411 and the third-party 401 to communicate and to share the data without the need for the third-party to access the identity hub 411 in the conventional manner. Rather, the communication is provisioned in the decentralized manner using the DID 205 and the DID document 210. This advantageously allows the DID owner to be in full control of the process.

As shown in FIG. 4, the third-party 402 also requests permission for access to the identity hub 411 using the DID 205 and the DID document 210. Accordingly, the embodiments disclosed herein allow access to any number of third parties to the identity hubs 410.

As briefly discussed above, the identity hub 411 is hosted in a cloud service. The service provider has access to the data stored in each user's identity hub 411. Furthermore, the service provider also has access to certain activities of the DID owner. For example, the entities with whom the DID owner has shared his/her data is stored in the identity hub 411. As another example, a user has multiple DIDs and has shared data amongst the multiple DIDs, alternatively, the user has used different DID management modules to access the same data. Based on the data sharing activities, the service provider of the identity hub 411 correlate the relationships of different DIDs and find out that two DIDs is related or owned by the same owner. Thus, the user's privacy is compromised.

The principles described herein will solve these potential privacy concerns of DID owners by encrypting the personal data stored in the identity hub 411. The encryption/decryption keys are not stored or accessible by the identity hub 411, so that the DID owners not only have great control over their data from other DID owners or users, but also have their privacy protected from the service providers.

There are many different objects stored in the identity hub 411. A data object is a file, a folder, or any portion of data stored in the identity hub 411. The whole identity hub 411 is encrypted with one encryption/decryption key as one object. Alternatively, a different portion of the data stored in the identity hub 411 is encrypted with different encryption/decryption keys.

In another example embodiment, verifiable claims (e.g., credential information 215) are issued and stored at the identity hub 411. For example, a verifiable claim that is associated with a DID owner 201 is issued by a claim issuing entity, and the issued verifiable claim is stored at the identity hub 411 that is associated with the DID owner 201. The DID owner 201 send the verifiable claim to another entity when the other entity requires to verify the credential of the DID owner. For example, the DID owner 201 is a person holding a driver's license, and the claim issuing entity is a DMV that has issued the DID owner's driver's license. The DMV issue a verifiable claim that verifies that the DID owner 201 is holding a valid driver's license. The DID owner 201 stores the verifiable claim in the identity hub 411. Another entity is a rental car company, which requires the DID owner 201 to show that he/she has a valid driver's license. The DID owner then sends the verifiable claim stored at the identity hub 411 to the rental car company.

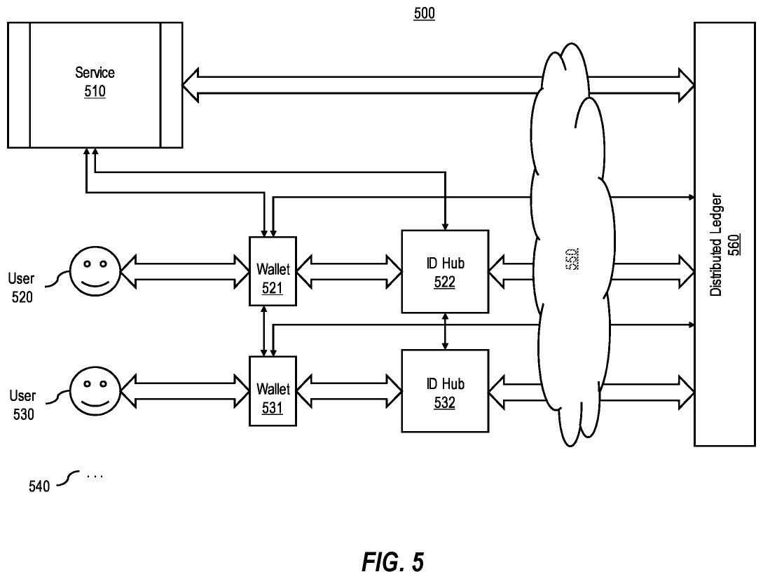

Having described DIDs and how they operate generally with reference to FIGS. 2-4, specific embodiments of decentralized identification will now be explained. Turning to FIG. 5, a decentralized environment 500 that allows DID owners to access services and perform transactions with other DID owners while identifying themselves will now be explained. It will be appreciated that FIG. 5 references elements from FIGS. 2-4 as needed for ease of explanation.

As illustrated in FIG. 5, the decentralized environment 500 includes a device associated with a service provider 510, a wallet apps 521 and 522 of users 520 and 530 (e.g., DID owners). The ellipsis 540 represents that there may be any number of devices associated with any number of service providers and/or users in the decentralized environment 500. Each of the service provider (s) and users 520, 530 corresponds to a DID owner 201 of FIG. 2. The wallet app 521 or 531 corresponds to the DID management module 320 of FIG. 3. The ID hub 522 or ID hub 532 corresponds to the ID hub 411 of FIG. 4.

User 520 uses a wallet app 521 to manage his/her DIDs, and user 520 uses a wallet app 531 to manage his/her DIDs. The wallet app 521 or 531 is connected to a respective ID hub 522 or 531. Each of the service provider's device 510 and wallet apps 521, 531 has access to the distributed ledger via a computer network 550. In some embodiments, the wallet app 521 or 531 has indirect access to the distributed ledger via the ID hub 522 or 532. In some embodiments, the wallet app 521 or 531 is configured to store a complete copy of the distributed ledger or has direct access to the distributed ledger via the computer network 550.

The device of the service provider 510 and each wallet apps 521, 531 and/or ID hubs 522, 532 are capable of communicating with each other via various communication channels, including, but not limited to, local area network, a wide area network, a BLE beacon signal, and/or near field communication (NFC). The communication can also be performed via generating a bar code or a QR code that by one wallet app 521, and scanning the bar code or a QR code by another wallet app 531 or the device of the service provider 510. The barcode or the QR code includes the identification information related to the user 520, such as the DID associated with the user 520.

In some embodiments, the service 510 may act as an issuer or as a relying party. As used herein, an “issuer” is an entity that makes at least one assertion about a subject. That assertion is also called herein a “claim”. A “credential” is a set of one or more claims. Examples of issuers include corporations, organizations, associations, governments, agencies, individuals, or any other entity that can make assertions that could be relied upon by others. Thus, the service 510 may provide one or more verifiable claims or credentials about the user 520 or user 530, who such instance act as a “holder”. The users 520 and 530 can store the verifiable claims in the ID hub 522 and ID hub 532 respectively. As used herein, a “relying party” is a party that relies on the verifiable claims or credentials so as to ascertain information about the holder and then provides a service to the holder.

For example, suppose that the service 510 is the Department of Motor Vehicles (DMV). While acting as an “issuer” the service 510 issues a verifiable claim to the user 520 that asserts that the user 520 has a valid driver's license issued by the DMV. The user 520 as the “holder” is then able to provide the verifiable claim related to the driver's license to a relaying party that needs this information. Suppose a relying party (not illustrated in this embodiment, although as mentioned above the service 510 can be a relying party in some embodiments) is a car rental agency. The user 520 presents the verifiable claim related to the driver's license to the car rental agency when he or she wants to rent a car and the car rental agency is able to use the verifiable claim related to the driver's license to ascertain that the user 520 has a valid driver's license that can be used to rent the car.

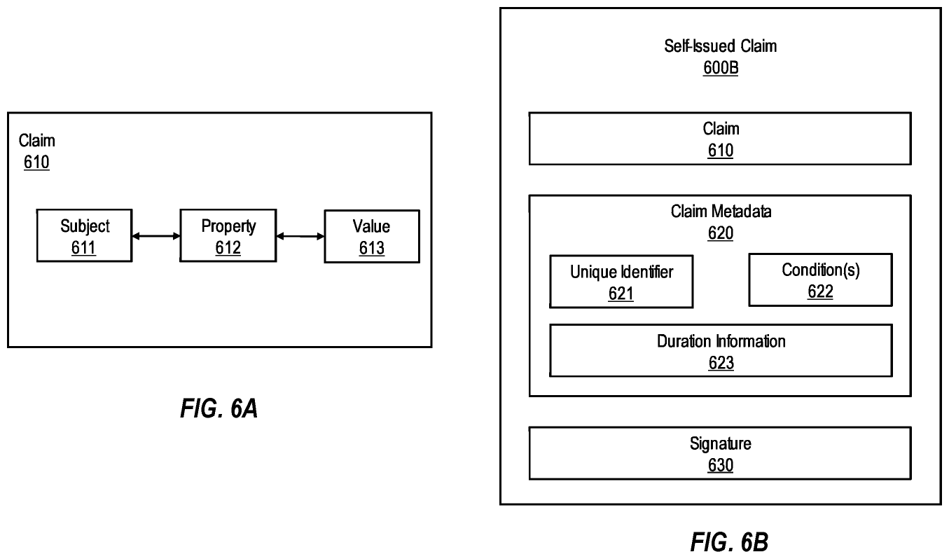

FIG. 6A illustrates an example data structure that represents a claim 610. The claim 610 includes a subject 611, a property 612 and a value 613. For example, the subject 611 corresponds to an owner of a DID (e.g. DID owner 201), and the DID (e.g. DID 205) is recorded as the subject 611. The property 612 may be any property of the owner of the DID, such as a name, a phone number, an email address, etc. The value 613 is the value of the corresponding property 612. For example, when the property is “name”, the value would be the name of the owner of the DID, e.g., John Doe; when the property is “phone number”, the value would be the phone number of the owner of the DID, e.g., 1-800-123-4567.

FIG. 6B illustrates an example data structure of a verifiable claim or credential 600B. In some embodiments, the data structure of the verifiable claim or credential is referred to as a Portable Identity Card (PIC) and is way for the issuer (e.g., service 510) to organize the verifiable claim in a manner that is easily understood by the user (e.g., user 520 or user 530). The verifiable claim or credential 600B includes claim 610, which corresponds to the claim 610 of FIG. 6A and includes the DID. The verifiable claim or credential 600B also includes a signature 630, which is generated by signing the claim 610 by a private key of the issuer. The signature 630 is typically a cryptographic mechanism (such as a digital signature) that is used to detect whether the verifiable claim or credential 600B has been tampered with since the time that the verifiable claim or credential 600B was issued, and can be used to verify identity of the issuer of the verifiable claim or credential 600B.

Once the verifiable claim or credential 600B is generated, at least a portion of data related to the verifiable claim or credential 600B is propagated onto a distributed ledger (e.g., 220, 560), such that a relying entity can use the portion of data propagated onto the distributed ledger to validate the verifiable claim or credential 600B. In some embodiments, the public key corresponding to the private key of the issuer is propagated onto the distributed ledger. In some embodiments, a hash of the public key or a hash of the verifiable claim or credential 600B is propagated onto the distributed ledger.

In some embodiments, the verifiable claim or credential 600B also includes various metadata related to the verifiable claim or credential 600B. For example, the metadata includes, but is not limited to, (1) a unique identifier identifying the corresponding verified claim or credential 621, (2) one or more conditions 622 for accessing the verifiable claim or credential 600B, or (3) duration information metadata 623 related to a duration of time that the issuer wants the verifiable claim or credential 600B to be valid for.

The one or more conditions metadata 622 for accessing the verifiable claim or credential 600B, but are not limited to, (1) requiring the relying entity to pay a predetermined amount of cryptocurrency, (2) requiring the relying entity to provide identification information, (3) requiring the relying entity to provide one or more verifiable claim(s), (4) requiring the relying entity to grant permission for accessing a portion of data, and/or (5) requiring the relying entity to provide a particular service.

The duration information metadata 623 includes, but is not limited to, (1) an expiration time of the corresponding verifiable claim or credential 600B, (2) a predetermined number of times that the corresponding verifiable claim or credential 600B can be accessed or used, (3) a mechanism that automatically causes the verifiable claim or credential 600B to expire in response to a directive from the issuer, or (4) a mechanism that allows the user to manually cause the verifiable claim or credential 600B to expire.

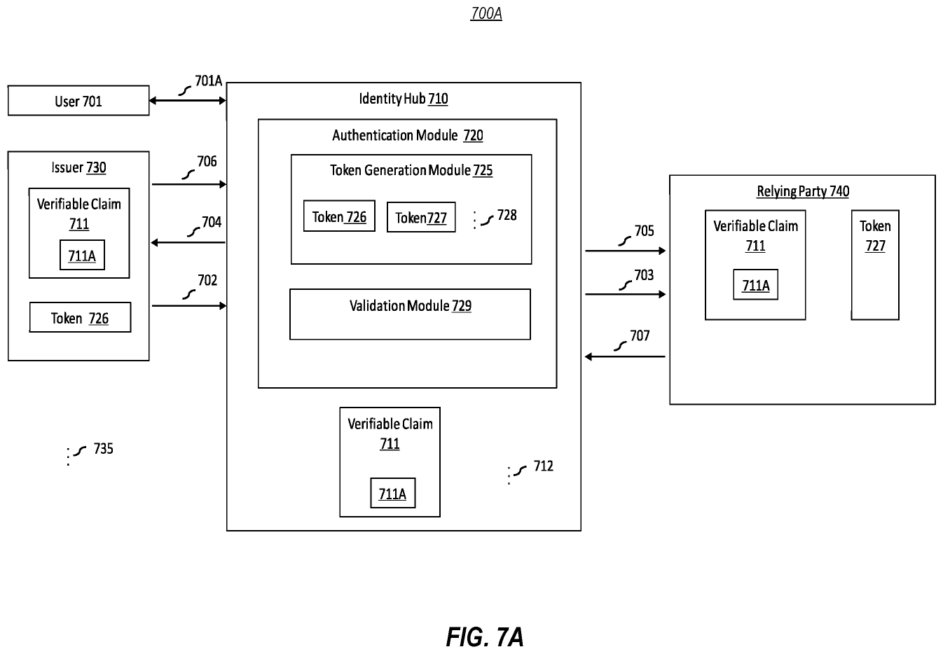

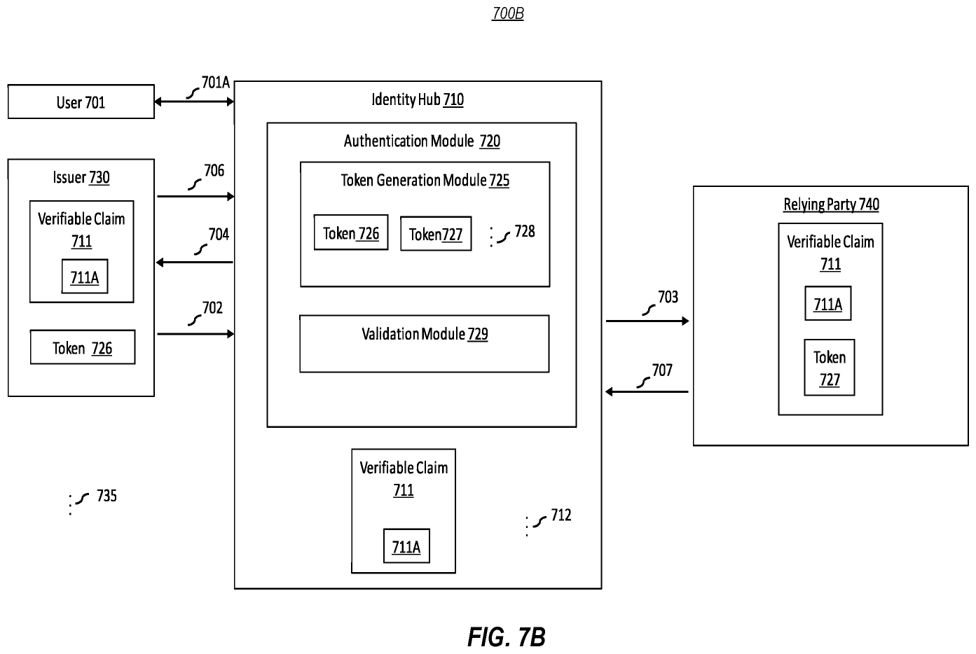

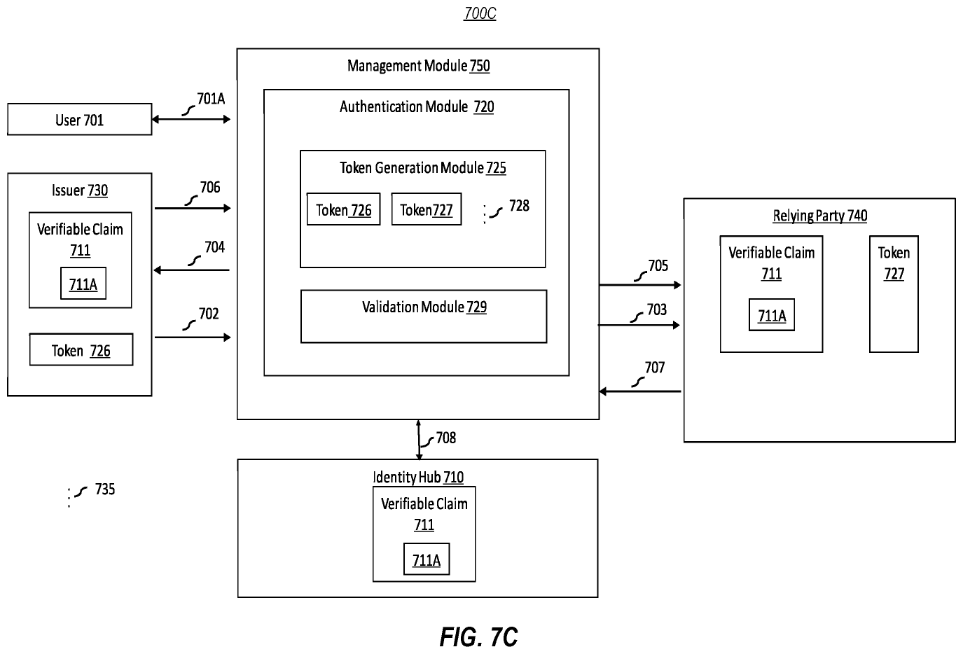

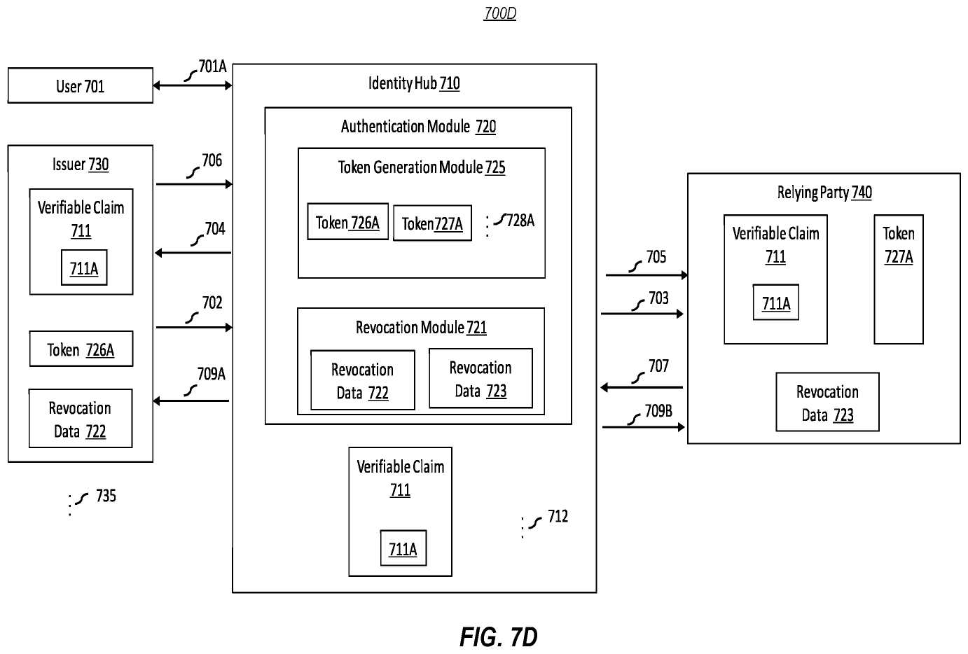

FIG. 7A illustrates an embodiment of an environment 700A that can be used to authorize access to a verifiable claim so that a user who is the subject of the verifiable claim need not actively authorize access to the verifiable claim. In this way, an entity such as an issuer of the verifiable claim or a relying party that relies on the verifiable claim to provide services to user (i.e., the holder) are able to access the verifiable claim when the user is not present. In other words, in instances where the user is “present” by physically presenting the verifiable claim to a relying party or is “present” by being online or the like, the user is able to actively authorize the access to the verifiable claim by showing the verifiable claim to the entity or by pushing a button or the like on a device. However, if the user is not able to physically present the verifiable claim or is not online and thus able to push the button on the device, the embodiments disclosed herein provide a way for the user to securely provide access to the verifiable claim so that it can be used or modified by the issuer and/or the relying party as needed. At a later date, the user is able to revoke the authorization to access the verifiable

As illustrated, the environment 700A includes a user 701, an identity hub 710 including an authentication module 720 that is controlled by or otherwise associated with the user 701, an issuer 730, any number of additional services as illustrated by the ellipses 735, and a relying party 740.

The issuer 730, which corresponds to the service 510 previously discussed, issues, as shown by arrow 702, a verifiable claim 711 on behalf the user 701, who corresponds to the DID owner 201 and the users 520, 530, and 540 previously described. The verifiable claim 711, which corresponds to the verifiable claim or credential 600B, in some embodiments may also include duration information metadata 711A, which corresponds to the duration information metadata 623. For example, the issuer 730 may be the DMV and issues a verifiable claim 711 that specifies that the user 701 has a valid driver's license. However, since the driver's license is only valid for a period of five years before needing to be renewed, the issuer 730 may include duration information metadata 711A that specifies that that the verifiable claim 711 will expire in five years. Thus, the duration information metadata 711A specifies an expiration time of the corresponding verifiable claim 711. As illustrated, the user 701 may include any number of additional verifiable claims as illustrated by ellipses 712 that are issued by any number of additional services as illustrated by the ellipses 735. The verifiable claims 711 and potentially 712 are stored in the identity hub 710. It will be appreciated, however, that the verifiable claims 711 and 713 may be stored in another storage or database such as database 305 as circumstances warrant. Accordingly, the embodiments disclosed herein are not limited by where the verifiable claims are stored.

The environment 700A includes a relying party 740, which corresponds to the service 510 when the service 510 is a relying party. As illustrated by the arrow 703 the user 701 provides the verifiable claim 711 to the relying party 740 to obtain a service or the like. For example, if the verifiable claim 711 specifies that the user 701 has a valid driver's license and the relying party 740 is a car rental agency, the user 701 provides the verifiable claim 711 so that he or she can rent a car.

The environment 700A includes the identity hub 710, which as illustrated by arrow 701A is controlled by or otherwise associated with the user 701 and corresponds to one of the identity hubs 410. As mentioned previously, there are instances where either the issuer 730 and/or the relying party 740 need to access the verifiable claim 711 that is stored in the identity hub 710. However, the user 701 may not always be able to actively provide authorization for the issuer 730 and/or the relying party 740 to access the verifiable claim that is stored in the identity hub 710.

Accordingly, the identity hub 710 also includes the authentication module 720. In operation, the authentication module 720 provides a secure way for the user 701 to provide access to the identity hub 710 when he or she is not able to actively provide authorization.

The authentication module 720 includes a token generation module 725. In operation, the token generation module generates access tokens that include access information that will allow an entity that presents the token to gain access, at least for a period of time, to the verifiable claim 711 that is stored in the identity hub 710. For example, the token generation module generates a first access token 226, a second access token 227, and potentially any number of additional access tokens as illustrated by the ellipses 228. In the embodiment, the access token 726 is configured to include the access information needed to allow the issuer 730 access to the verifiable claim 711 stored in the identity hub 710 and the access token 727 is configured to include the access information needed to allow the relying party 740 to access the verifiable claim 711 stored in the identity hub. As shown at arrows 704 and 705, the authentication module 720 provides the access token 726 to the issuer 730 and the access token 727 to the relying party 740 for use when the user 701 is not able to actively provide authorization.

The authentication module 720 includes a validation module 729. In operation, the validation module 729 receives the access token 726 and 727 from the issuer 730 and/or the relying party 740 as shown by arrows 706 and 707 when either of these entities attempts to access the verifiable claim 711 stored in the identity hub 710. The validation module 729 then determines if the access tokens are still valid. If they are still valid, the validation module 729 allows access to the verifiable claim 711. Specific cases of using the access tokens 726 and 727 will be discussed in more detail to follow.

FIG. 7B illustrates an embodiment of an environment 700B that is a modification of the environment 700A of FIG. 7A. Accordingly, elements that were described in relation to environment 700A need not be described again in relation to environment 700B.

As discussed above, in environment 700A the access token 727 is provided to the relying party 740 at a time after the verifiable claim 711 is presented to the relying party by the user 710. However, this need not always be the case. As shown in FIG. 7B, in some embodiments the access token 727 is attached to the verifiable claim 711 by the authentication module 720 before the verifiable claim is provided to the relying party 740. As shown by arrow 703, the verifiable claim 711 having the access token 727 attached is then provided to the relying party 740. The access token 727 can then be used by the relying party 740 in the manner described herein.

FIG. 7C illustrates an embodiment of an environment 700C that is a modification of the environment 700A of FIG. 7A. Accordingly, elements that were described in relation to environment 700A need not be described again in relation to environment 700C.

As discussed above, in environment 700A the authentication module 720 is included as part of or otherwise associated with the identity hub 710. However, in the embodiment of environment 700C, the authentication module 720 is included as part of or otherwise associated with a management module 750, which corresponds to the DID management module 320 discussed in relation to FIG. 3. Thus, the authentication module 720 can be implemented on a device such as user device 301 that is in control of the user 701. As shown by arrow 708, in this embodiment the authentication module 720 included as part of the management module 750 communicates with the identity hub 710. This communication allows the authentication module 720 to cause the identity hub 710 to receive the verifiable claim from the issuer 730 and to provide the verifiable claim 711 to the relying party 740. The access tokens 726 and 727 can then be generated and used by the relying party 740 in the manner described herein.

FIG. 7D illustrates an embodiment of an environment 700D that is a modification of the environment 700A of FIG. 7A. Accordingly, elements that were described in relation to environment 700A need not be described again in relation to environment 700D.

In some embodiments, the access tokens 726 and 727 (and potentially the access tokens 728) may be set to expire after a predetermined amount of time. This is done to increase security as the access tokens will expire after the predetermined amount of time and therefore cannot be used by a malicious party that may steal the access tokens. Accordingly, in the embodiment of the environment of 700D, the token generation module 725 generates refresh tokens 226A, 227A, and potentially any number of additional refresh tokens as illustrated by ellipses 728A. The refresh tokens can be provided to the issuer 730 and/or the relying party 740 at predetermined intervals as determined by the user 701. The refresh tokens can then be used to replace any expired access tokens so that access can be maintained as needed by the issuer 730 and/or relying party 740.

In some instances, the user 701 may desire to revoke access to the identity hub 710 and the verifiable claim 711. For example, the user 701 may no longer desire to receive any services from the relying party 740 or may no longer need the verifiable claim 711 and so may not need to give the issuer 730 access to update the verifiable claim.

Accordingly, in the embodiment the authentication module 720 includes a revocation module 721. In operation, the revocation module 721 generated revocation data 722 and 723. The revocation data 722 and 723 is configured to revoke the access tokens 726 and 727. As shown by arrow 709A, the revocation data 722 is provided to the issuer 730 to revoke the access token 726. Upon receipt of the revocation data 722, the access token 726 is revoked. As shown by the arrow 709B, the revocation data is provided to the relying party 740 to revoke the access token 727, Upon receipt of the revocation data 723, the revocation data is revoked.

For example, suppose that user 701 moves to a new state and thus no longer needs the verifiable claim 711 issued by the DMV (e.g., issuer 730) and therefore does not need to provide access to the issuer 730. Accordingly, the revocation module 721 can generate the revocation data 722 and provide it to the issuer 730 to revoke the access token 726. Likewise, suppose that the relying party 740 is the car rental agency and the user 701 ends the rental period and thus no longer needs to provide access to the relying party 740. Accordingly, the revocation module 721 can generate the revocation data 723 and provide it to the relying party to revoke the access token 727.

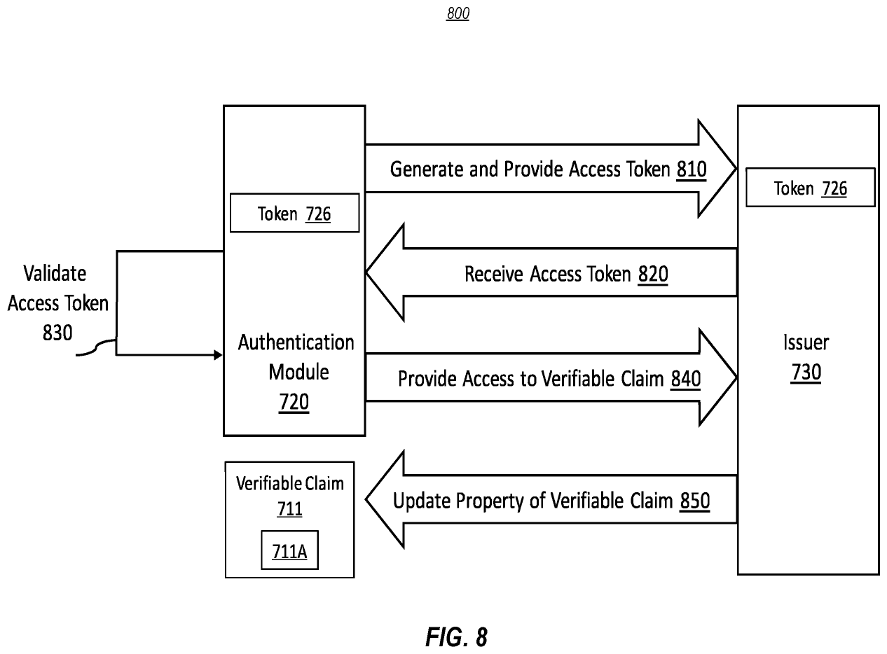

A specific case of use by the issuer 730 of the access token 726 will now be explained in relation to an environment 800 of FIG. 8. In the use case, suppose that the issuer 730 is the DMV described previously and that the verifiable claim 711 specifies that the user 701 has a valid drivers license and includes the duration information metadata 711A that specifies a time period the drivers license is valid. As shown at 810, the authentication module 720 generates and then provides the access token 726 to the issuer 730. The step 810 may occur at any time period after the issuer 730 has issued the verifiable claim 711 on behalf of the user 701 and the verifiable claim 711 has been stored in the identity hub 710 or some other storage location such as database 305.

At a time period after the access token has been provided to the issuer 730, the issuer 730 has a need to access the verifiable claim 711. For example, the driver's license of the user 701 may be about to expire and the DMV needs to update the duration information metadata 711A so as to extend the time period the driver's license is valid. Accordingly, as shown at 820 the issuer 730 provides and the authentication module 720 receives the access token 726. As shown at 830, the authentication module 720 validates the access token 726 received from the issuer 730. If the access token 726 is valid (i.e., has not expired and still includes the information authorizing access to the verifiable claim 711), then the issuer 730 is provided access to verifiable claim 711 as shown at 840. Of course, if the access token 726 is not validated, then access will be denied. Providing access to the issuer 730 means that the issuer 730 is able to access the identity hub 710 and to access the verifiable claim 711 stored in the identity hub 710. The access token 726, however, will not provide access to other areas of the identity hub 710 so as to maintain security for the user 701 for other data stored in the identity hub.

Once the issuer 730 has gained access, the issuer is able to update one or more properties of the verifiable claim. For example, in the case of the expiring driver's license, the issuer 730 as the DMV is able to update the duration information metadata 711A to a new time period that extends the life of the driver's license. The issuer 730 is also able to update any other property 612, value 613, or metadata 620 of the verifiable claim 711 as deemed necessary by the issuer 730. As mentioned above, the user 701 need not actively be involved in this update process and indeed need not even be aware it is happening. Use of the access token 726 allows for the update process to occur between the issuer 730, the authentication module 720, and the identity hub 710 as needed without any active participation by the user 701.

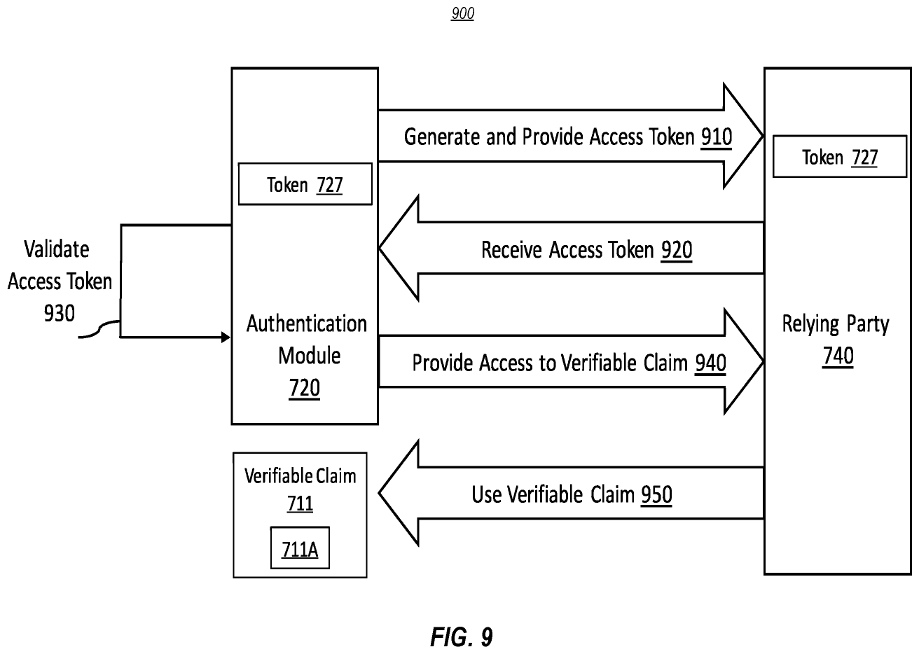

A specific case of use by the relying party of the access token 727 will now be explained in relation to an environment 900 of FIG. 9. In the use case, suppose that relying party 740 is the car rental agency and that the user 701 rents a car for multiple months, requiring the car rental agency to access the verifiable claim 711 in the identity hub 710 on a monthly basis to verify that the driver's license specified by the verifiable claim 711 is still valid. As shown at 910, the authentication module 720 generates and then provides the access token 727 to the relying party 740. The step 910 may occur at any time period after the user 701 initially provides the verifiable claim 711 to the relying party 740. Alternatively, the step 910 may occur at the time the verifiable claim 711 is provided to the relying party in those embodiments where the access token 727 is attached to the verifiable claim 711.

At a time period after the access token 727 has been provided to the relying party 740, the relying party has a need to access the verifiable claim 711 to ascertain that the driver's license is still valid. Accordingly, as shown at 920 the relying party 740 provides and the authentication module 720 receives the access token 727. As shown at 930, the authentication module validates the access token 727 received from the relying party 740. If the access token 727 is valid (i.e., has not expired and still includes the information authorizing access to the verifiable claim 711), then the relying party 740 is provided access to verifiable claim 711 as shown at 940. Of course, if the access token 727 is not validated, then access will be denied. Providing access to the relying party 740 means that the relying party 740 is able to access the identity hub 710 and to access the verifiable claim 711 stored in the identity hub. The access token 727, however, will not provide access to other areas of the identity hub 710 so as to maintain security for the user 701 for other data stored in the identity hub.

Once the relying party 740 has gained access, the relying party 740 is able to use the verifiable claim 711 to provide services to the user 701. For example, in the case of the user renting the car for multiple months, the relying party 740 is able to verify that the driver's license is still valid and so continues to rent the car to the user 701. As mentioned above, the user 701 need not actively be involved in this process and indeed need not even be aware it is happening. Use of the access token 727 allows for the process to occur between the relying party 740, the authentication module 720, and the identity hub 710 as needed without any active participation by the user 701.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

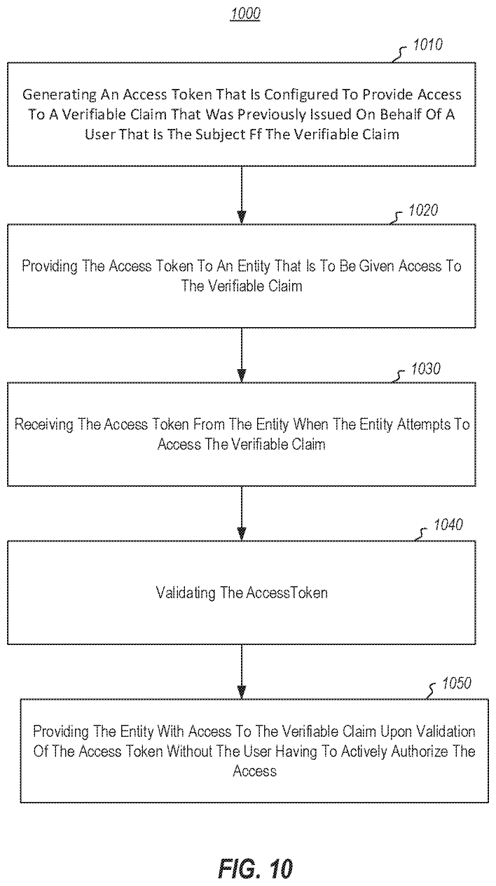

FIG. 10 illustrates a flow chart of an example method 1000 for authorizing access to a verifiable claim so that a user who is the subject of the verifiable claim need not actively authorize the access. The method 1000 will be described with respect to one or more of FIGS. 2-9 discussed previously.

The method 1000 includes generating an access token that is configured to provide access to a verifiable claim that was previously issued on behalf of a user that is the subject of the verifiable claim 1010). For example, as previously discussed the token generation module 725 generates the access tokens 726, 727, and potentially 728. The access tokens are structured with the needed information to allow the issuer 730 and/or the relying party 740 to access the verifiable claim 711 stored in the identity hub 710.

The method 1000 includes providing the access token to an entity that is to be given access to the verifiable claim 1020). For example, as previously discussed the authentication module 720 provides the access token 726 to the issuer 730 and the access token 727 to the relying party 740.

The method 1000 includes receiving the access token from the entity when the entity attempts to access the verifiable claim 1030). For example, as previously discussed the authentication module 720 receives the access token 726 from the issuer 730 when the issuer 730 attempts to access the verifiable claim 711. Likewise, the authentication module 720 receives the access token 727 from the relying party 740 when the relying party 740 attempts to access the verifiable claim 711.

The method 1000 includes validating the access token (1040). For example, as previously discussed the validation module 729 validates the access token 726 received from the issuer 730 and validates the access token 727 received from the relying party 740.

The method 1000 includes providing the entity with access to the verifiable claim upon validation of the access token without the user having to actively authorize the access (1050). For example, as previously discussed the issuer 730 and/or the relying party 740 are given access to the verifiable claim stored in the identity hub 710. As discussed, the user 701 need not actively authorize the access.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system for authorizing access to a verifiable claim so that a user who is the subject of the verifiable claim need not actively authorize the access, the computing system comprising:
one or more processors; and
one or more computer-readable media having thereon computer-executable instructions that are structured such that, when executed by the one or more processors, cause the computing system to:
generate an access token that is configured to provide access to a verifiable claim that was previously issued on behalf of a user that is the subject of the verifiable claim;
provide the access token to an entity that is to be given access to the verifiable claim;
receive the access token from the entity when the entity attempts to access the verifiable claim;
validate the access token; and
provide the entity with access to the verifiable claim upon validation of the access token without the user having to actively authorize the access.

2. The computing system of claim 1, further comprising:
attaching the access token to the verifiable claim; and
providing the verifiable claim to the entity.

3. The computing system of claim 1, wherein the entity is an issuing entity that issued the verifiable claim on behalf of the user.

4. The computing system of claim 1, wherein the entity is a relying party that uses the verifiable claim when providing a service to the user.

5. The computing system of claim 1, wherein providing the entity with access to the verifiable claim comprises:
allowing the entity to update one or more properties of the verifiable claim.

6. The computing system of claim 5, wherein updating the one or more properties of the verifiable claim comprises:
updating duration information metadata that specifies a time period that the verifiable claim is valid or a predetermined number of times the verifiable is valid for use.

7. The computing system of claim 1, wherein providing the entity with access to the verifiable claim comprises:
allowing the entity to use the verifiable claim when providing a service to the user.

8. The computing system of claim 1, wherein the verifiable claim comprises at least (1) a Decentralized Identifier (DID), (2) a property of the subject entity, (3) a value corresponding to the property, (4) a unique identifier identifying the corresponding verifiable claim, and (5) one or more conditions for accessing the verifiable claim.

9. The computing system of claim 8, the one or more conditions comprising at least one of the following: (1) requiring a relying entity to pay a predetermined amount of value, (2) requiring a relying entity to provide identification information, (3) requiring a relying entity to provide one or more verifiable claim(s), (4) requiring a relying entity to grant permission for accessing a portion of data, or (5) requiring a relying entity to provide a particular service.

10. The computing system of claim 1, further comprising:
generating revocation data that is configured to revoke the access token;
providing the revocation data to the entity; and
revoking the access to the verifiable claim.

11. The computing system of claim 1, wherein the computing system is associated with a management module controlled by the user.

12. The computing system of claim 1, wherein the computing system is associated with an identity hub controlled by the user.

13. The computing system of claim 1, wherein the verifiable claim is stored in an identity hub controlled by the user.

14. A method for authorizing access to a verifiable claim so that a user who is the subject of the verifiable claim need not actively authorize the access, the method comprising:
generating an access token that is configured to provide access to a verifiable claim that was previously issued on behalf of a user that is the subject of the verifiable claim;
providing the access token to an entity that is to be given access to the verifiable claim;
receiving the access token from the entity when the entity attempts to access the verifiable claim;
validating the access token; and
providing the entity with access to the verifiable claim upon validation of the access token without the user having to actively authorize the access.

15. The method of claim 14, further comprising:
attaching the access token to the verifiable claim; and
providing the verifiable claim to the entity.

16. The method of claim 14, wherein providing the entity with access to the verifiable claim comprises:
allowing the entity to update one or more properties of the verifiable claim.

17. The method of claim 16, wherein updating the one or more properties of the verifiable claim comprises:
updating duration information metadata that specifies a time period that the verifiable claim is valid or a predetermined number of times the verifiable is valid for use.

18. The method of claim 14, wherein providing the entity with access to the verifiable claim comprises:
allowing the entity to use the verifiable claim when providing a service to the user.

19. The method of claim 14, further comprising:
generating revocation data that is configured to revoke the access token;
providing the revocation data to the entity; and
revoking the access to the verifiable claim.

20. A computer program product comprising one or more computer-readable storage media having thereon computer-executable instructions that are structured such that, when executed by one or more processors of a computing system, cause the computing system to perform a method for authorizing access to a verifiable claim so that a user who is the subject of the verifiable claim need not actively authorize the access, the method comprising:
generating an access token that is configured to provide access to a verifiable claim that was previously issued on behalf of a user that is the subject of the verifiable claim;
providing the access token to an entity that is to be given access to the verifiable claim;
receiving the access token from the entity when the entity attempts to access the verifiable claim;
validating the access token; and
providing the entity with access to the verifiable claim upon validation of the access token without the user having to actively authorize the access.
